(19) United States
(12) Patent Application Publication
(10) Pub. No.: US 2021/0331225 A1
(43) Pub. Date: Oct. 28, 2021

(54) WATER-BASED GRINDING MACHINE FOR POLISHING SURFACE OF A METAL STRIP

(71) Applicant: Kun Shan Futianda Metal Technology Co.,Ltd., Kunshan (CN)

(72) Inventor: Xing ZHANG, Kunshan (CN)

(21) Appl. No.: 17/367,540

(22) Filed: Jul. 5, 2021

(30) Foreign Application Priority Data
Nov. 27, 2020 (CN) 202011360398.1

(51) Int. Cl. B21C 43/02; B24B 27/00; B24B 7/13; B24B 57/02; B24B 37/08

(52) U.S. Cl. CPC B21C 43/02; B24B 27/0076; B24B 37/08; B24B 57/02; B24B 7/13

(57) ABSTRACT

A water-based grinding machine for polishing a surface of a metal strip includes an unwinding wheel, a polishing mechanism, a cleaning mechanism, a drying mechanism and a winding wheel. The polishing mechanism includes a first polishing wheel and a first workbench. The metal strip is drawn from the unwinding wheel into a gap between a polishing wheel and a pad, and then is drawn to the cleaning mechanism. The cleaning mechanism includes a third workbench and a cleaning liquid storage tank. At least one pair of felt wheels is arranged above the third workbench. The metal strip passes through a gap between the at least one pair of felt wheels. An outer circumference of the at least one pair of felt wheels is covered with a wool layer. The cleaning liquid storage tank is provided with a cleaning pipe. The drying mechanism includes an oven.

### CROSS-REFERENCE TO RELATED APPLICATIONS

This application claims the benefit of priority from Chinese Patent Application No. 202011360398.1, filed on Nov. 27, 2020. The content of the aforementioned application, including any intervening amendments thereto, is incorporated herein by reference in its entirety.

### TECHNICAL FIELD

This application relates to devices for polishing metal strips, and more particularly to a water-based grinding machine for polishing a surface of a metal strip.

### BACKGROUND

Metal strip is an important basic material that can be used to make many products and parts. In the practical use, the metal strip is usually required to have high surface glossiness and low roughness, and in view of this, it is often subjected to a polishing treatment in advance. Generally, the surface of the metal strip is ground and polished by a polishing wheel of a grinding-polishing device. Some products require the metal strip to have a surface roughness Ra less than 0.1 μm; however, the metal strip generally have a surface roughness Ra of 0.15-0.2 μm, raising high requirements for the processing precision of the polishing device.

### SUMMARY

An objective of the present disclosure is to provide a water-based grinding machine for polishing a surface of a metal strip, which enables the precise polishing of a metal strip with a low polishing amount.

Technical solutions of this application are specifically described as follows.

The present disclosure provides a water-based grinding machine for polishing a surface of a metal strip, comprising:

an unwinding wheel;

a polishing mechanism;

a cleaning mechanism;

a drying mechanism; and

a winding wheel;

wherein the unwinding wheel, the polishing mechanism, the cleaning mechanism the drying mechanism and the winding wheel are linearly arranged in sequence; the polishing mechanism comprises a first polishing wheel and a first workbench; a first pad is arranged under the first polishing wheel; the first pad is arranged on a support; the support is arranged on the first workbench; the support is provided with a screw and a first threaded hole matching the screw; the first workbench is provided with a second threaded hole matching the screw; the screw passes through the first threaded hole and the second threaded hole; a top of the screw abuts against a top of the support; the metal strip is drawn from the unwinding wheel to a gap between the first polishing wheel and the first pad, and then drawn to the cleaning mechanism; the cleaning mechanism comprises a second workbench and a cleaning liquid storage tank; the cleaning liquid storage tank is configured to store a cleaning liquid for cleaning the metal strip; at least one pair of felt wheels are arranged above the second workbench; the metal strip passes through the at least one pair of felt wheels; an outer circumference of the at least one pair of felt wheels is covered with a wool layer; the cleaning liquid storage tank is provided with a cleaning pipe; an upper end of the cleaning pipe is communicated with the cleaning liquid storage tank; a lower end of the cleaning pipe points to an upper surface of the metal strip; the drying mechanism comprises an oven; and after passing through the cleaning mechanism, the metal strip enters the oven, and then is wound onto the winding wheel.

In some embodiments, a tension pulley is arranged between the unwinding wheel and the first polishing wheel; and the metal strip passes on the tension pulley.

In some embodiments, the support comprises a support plate, a bottom plate and a guiding column, and the guiding column is arranged between the support plate and the bottom plate.

In some embodiments, a first cover is arranged on the first workbench; a first polishing liquid storage tank is arranged on the first cover; a first polishing liquid dropper is arranged on the first polishing liquid storage tank; an upper end of the first polishing liquid dropper is communicated with the first polishing liquid storage tank; and a lower end of the first polishing liquid dropper points to the upper surface of the metal strip below the first polishing wheel.

In some embodiments, a third workbench is arranged beside the first workbench; a second pad is arranged on the third workbench; a second polishing wheel is arranged above the second pad; and the metal strip passes through a gap between the second polishing wheel and the second pad.

In some embodiments, a second cover is arranged on the third workbench; a second polishing liquid storage tank is arranged on the second cover; a second polishing liquid dropper is arranged on the second polishing liquid storage tank; an upper end of the second polishing liquid dropper is communicated with the second polishing liquid storage tank; a lower end of the second polishing liquid dropper points to the upper surface of the metal strip below the second polishing wheel; and a stirrer is arranged in the second polishing liquid storage tank.

In some embodiments, a first drain pipe is arranged on the first workbench; the first drain pipe has an upper-end opening, which is located on an upper surface of the first workbench; a sedimentation tank is provided below the third workbench; a lower end of the first drain pipe extends into the sedimentation tank; the third workbench is provided with a second drain pipe; the second drain pipe has an upper-end opening, which is located on an upper surface of the third workbench; and a lower end of the second drain pipe extends into the sedimentation tank.

In some embodiments, a third cover is arranged on the second workbench; and the at least one pair of felt wheels is arranged in the third cover.

In some embodiments, a cleaning liquid recovery tank is arranged below the second workbench; the second workbench is provided with a third drain pipe; the third drain pipe has an upper-end opening, which is located on an upper surface of the second workbench; and a lower end of the third drain pipe extends into the cleaning liquid recovery tank.

The beneficial effects of the present disclosure are described as follows.

In the water-based grinding machine provided herein for polishing a metal strip surface, the pressure of the polishing wheel on the metal strip can be adjusted through the screw, and the polishing amount can be adjusted by adjusting the gap between the pad and the polishing wheel, so as to achieve the precise polishing of the metal strip. In addition, the cleaning mechanism and the drying mechanism are provided to respectively clean and dry the polished metal strip to obtain a clean and dry metal strip product that can be directly packaged.

### BRIEF DESCRIPTION OF THE DRAWINGS

The present disclosure will be further described with reference to the accompanying drawings to make the technical solutions clearer. Obviously, presented in the accompanying drawings are part of the embodiments of this disclosure, and other accompanying drawings can be obtained by those skilled in the art based on these drawings without paying creative effort.

FIG. 1 schematically depicts a structure of a water-based grinding machine for polishing a surface of a metal strip in accordance with an embodiment of the present disclosure;

FIG. 2 is a partial enlarged view of FIG. 1;

FIG. 3 schematically depicts a structure of a drying mechanism in accordance with an embodiment of the present disclosure; and

FIG. 4 schematically depicts an arrangement of a winding wheel and a motor in accordance with an embodiment of the present disclosure.

In the drawings, 1, unwinding wheel; 2, metal strip; 3, tension pulley; 4, guiding column; 51, first polishing liquid dropper; 52, second polishing liquid dropper; 6, first cover; 7, first polishing liquid storage tank; 81, first polishing wheel; 82, second polishing wheel; 91, first pad; 92, second pad; 101, bottom plate; 102, support plate; 103, guiding column; 11, second polishing liquid storage tank; 12, stirrer; 13, second cover; 14, third workbench; 15, second drain pipe; 16, sedimentation tank; 17, screw; 18, first drain pipe; 191, first threaded hole; 192, second threaded hole; 20, first workbench; 21, cleaning liquid storage tank; 22, felt wheel; 23, wool layer; 24, cleaning pipe; 25, cleaning liquid recovery tank; 26, third drain pipe; 27, third cover; 28, second workbench; 29, oven; 30, winding wheel; 31, air heater; 32, air duct; and 33, motor.

### DETAILED DESCRIPTION OF EMBODIMENTS

Technical solutions of the present disclosure will be clearly and completely described below with reference to the embodiments. Obviously, the presented embodiments are merely part of the embodiments of this disclosure, and other embodiments made by those skilled in the art based on the content disclosed herein without paying creative effort should fall within the scope of the disclosure.

### Embodiment 1

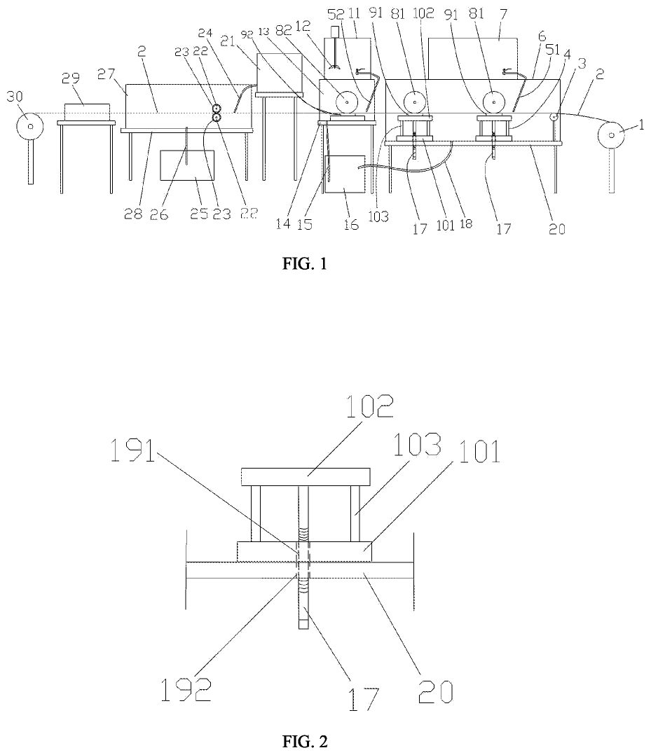

As shown in FIGS. 1-4, the present disclosure provides a water-based grinding machine for polishing a surface of a metal strip, which includes an unwinding wheel 1, a polishing mechanism, a cleaning mechanism, a drying mechanism and a winding wheel 30. The unwinding wheel 1, the polishing mechanism, the cleaning mechanism, the drying mechanism and the winding wheel 30 are linearly arranged in sequence. The polishing mechanism includes a first polishing wheel 81 and a first workbench 20. A first pad 91 is arranged under the first polishing wheel 81. The first pad 91 is arranged on a support. The support is arranged on the first workbench 20. The support is provided with a screw 17 and a first threaded hole 191 matching the screw 17. The first workbench 20 is provided with a second threaded hole 192 matching the screw 17. The screw 17 passes through the first threaded hole 191 and the second threaded hole 192. A top of the screw 17 abuts against a top of the support. The metal strip 2 is drawn from the unwinding wheel 1 to a gap between the first polishing wheel 81 and the first pad 91, and then drawn to the cleaning mechanism. The cleaning mechanism includes a second workbench 28 and a cleaning liquid storage tank 21. The cleaning liquid storage tank 21 is configured to store a cleaning liquid for cleaning the metal strip 2. At least one pair of felt wheels 22 is arranged above the second workbench 28. The metal strip 2 passes through the felt wheels 22. An outer circumference of the felt wheels 22 is covered with a wool layer 23, that is, the outer circumference of the felt wheels 2 is covered with wool. The cleaning liquid storage tank 21 is provided with a cleaning pipe 24. An upper end of the cleaning pipe 24 is communicated with the cleaning liquid storage tank 21. A lower end of the cleaning pipe 24 points to an upper surface of the metal strip 2. The drying mechanism includes an oven 29. After passing through the cleaning mechanism, the metal strip 2 enters the oven 29, and then is wound onto the winding wheel 30.

The support includes a support plate 102, a bottom plate 101 and a guiding column 103, and the guiding column 103 is arranged between the support plate 102 and the bottom plate 101.

A first cover 6 is arranged on the first workbench 20. A first polishing liquid storage tank 7 is arranged on the first cover 6. A first polishing liquid dropper 51 is arranged on the first polishing liquid storage tank 7. An upper end of the first polishing liquid dropper 51 is communicated with the first polishing liquid storage tank 7. A lower end of the first polishing liquid dropper 51 points to the upper surface of the metal strip 2 below the first polishing wheel 81.

The metal strip 2 is wound on the unwinding wheel 1 in a roll. When the polishing treatment is required, the metal strip 2 is pulled out of the unwinding wheel 1 into the gap between the first polishing wheel 81 and the first pad 91. The first polishing wheel 81 is in contact with the upper surface of the material strip 2. The gap between the first polishing wheel 81 and the first pad 91 is adjusted to adjust a polishing amount. A motor (not shown) drives the first polishing wheel 81 to rotate, such that the first polishing wheel 81 polishes the upper surface of the metal strip 2. The polishing amount can be adjusted by a screw 17. The screw 17 rises to lift up the support and the first pad 91 to reduce the gap between the first polishing wheel 81 and the first pad 91 and increase a polishing pressure of the first polishing wheel 81 on the metal strip 2. On the contrary, the polishing pressure of the first polishing wheel 81 on the metal strip 2 can be reduced by lowering the screw 17. During the polishing, the first polishing liquid storage tank 7 on the first cover 6 is filled with a polishing liquid. The polishing liquid drips from the lower end of the first polishing liquid dropper 51 onto the metal strip 2 near the first polishing wheel 81. The polishing liquid can cool the metal strip, and the ingredients in the polishing liquid can improve the polishing effect and make the surface of the metal strip smoother.

A third workbench 14 is arranged beside the first workbench 20. A second pad 92 is arranged on the third workbench 14. A second polishing wheel 82 is arranged on the second pad 92, and the metal strip 2 passes between the second polishing wheel 82 and the second pad 92.

A tension pulley 3 is arranged between the unwinding wheel 1 and the first polishing wheel 81. The metal strip 2 passes on the tension pulley 3. The tension pulley 3 can make the metal strip 2 in a tensioned state, which is beneficial to the polishing.

A second cover 13 is arranged on the third workbench 14. A second polishing liquid storage tank 11 is arranged on the second cover 13. A second polishing liquid dropper 52 is arranged on the second polishing liquid storage tank 11. An upper end of the second polishing liquid dropper 52 is communicated with the second polishing liquid storage tank 11. A lower end of the second polishing liquid dropper 52 points to the upper surface of the metal strip 2 below the second polishing wheel 82. A stirrer 12 is arranged in the second polishing liquid storage tank 11. The stirrer 12 is configured to stir a polishing liquid in the second polishing liquid storage tank 11, such that fine particle ingredients in the polishing liquid are mixed more evenly, and thus the polishing on the surface of the metal strip 2 is more uniform to allow the metal strip 2 to have a smoother surface with a smaller roughness. A surface roughness Ra of the metal strip 2 is less than 0.1 μm.

A first drain pipe 18 is arranged on the first workbench 20. The first drain pipe 18 has an upper-end opening, which is located on an upper surface of the first workbench 20. A sedimentation tank 16 is provided below the third workbench 14. A lower end of the first drain pipe 18 extends into the sedimentation tank 16. The third workbench 14 is provided with a second drain pipe 15. The second drain pipe 15 has an upper-end opening, which is located on an upper surface of the third workbench 14. A lower end of the second drain pipe 15 extends into the sedimentation tank 16. The polishing liquid accumulated on the first workbench 20 and the third workbench 14 flows into the sedimentation tank 16 through the first drain pipe 18 and the second drain pipe 15 respectively for sedimentation recovery.

A third cover 27 is arranged on the second workbench 28. The at least one pair of felt wheels 22 is arranged in the third cover 27. The metal strip 2 to be cleaned passes through a gap between the at least one pair of felt wheels 22. The cleaning liquid flows from the cleaning liquid storage tank 21 to the upper surface of the metal strip 2 through the cleaning pipe 24 to clean the polished metal strip 2. The cleaned metal strip 2 passes the gap between the at least one pair of felt wheels 22, and is wiped by the wool layer 23 on outer circumference of the at least one pair of felt wheels 22 to remove the cleaning liquid. The wool is soft and will not damage the surface of the metal strip 2.

A cleaning liquid recovery tank 25 is arranged below the second workbench 28. The second workbench 28 is provided with a third drain pipe 26. The third drain pipe 26 has an upper-end opening, which is located on an upper surface of the second workbench 28. A lower end of the third drain pipe 26 extends into the cleaning liquid recovery tank 25. The cleaning liquid flowing out of the cleaning pipe 24 flows to the second workbench 28, and then flows into the cleaning liquid recovery tank 25 through the third drain pipe 26, in which the cleaning liquid is recovered. The recovered cleaning liquid is subjected to a harmless and environmentally-friendly treatment.

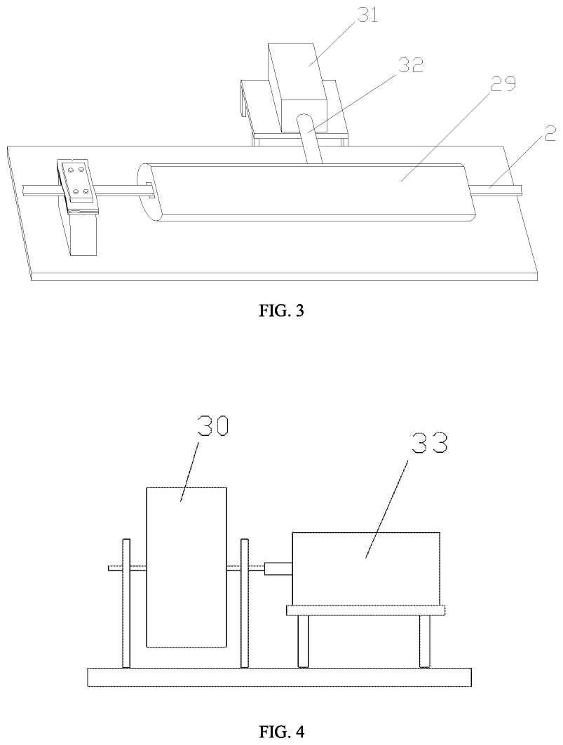

The cleaned metal strip 2 enters the drying mechanism. As shown in FIG. 3, the drying mechanism includes the oven 29, an air heater 31 and an air duct 32. Hot air generated by the air heater 31 enters the oven 29 through the air duct 32. After being dried in an oven 29, the metal strip 2 is wound onto the winding wheel 30. The movement and winding of the metal strip 2 to the winding wheel 30 are driven by a motor 33 at the winding wheel 30. As shown in FIG. 4, a working shaft of the motor 33 is fixedly connected to a central axis of the winding wheel 30.

The water-based grinding machine for polishing a metal strip surface adjusts the pressure of the polishing wheel on the metal strip through the screw, and reduces or increases the gap between the pad and the polishing wheel to adjust the polishing amount, so as to achieve precise polishing of the metal strip. The surface roughness Ra of the metal strip product can be polished to less than 0.1 μm. In addition, the water-based grinding machine is equipped with the cleaning mechanism and the drying mechanism, which can clean and dry the polished metal strip to obtain a clean metal strip product that can be directly packaged.

The above-mentioned embodiments are merely illustrative of this disclosure, and not intended to limit the present disclosure. Any variations and modifications made by those skilled in the art without departing from the spirit of this disclosure should fall within the scope of the present disclosure defined by the appended claims.

What is claimed is:

1. A water-based grinding machine for polishing a metal strip surface, comprising:
an unwinding wheel;
a polishing mechanism;
a cleaning mechanism;
a drying mechanism; and
a winding wheel;
wherein the unwinding wheel, the polishing mechanism, the cleaning mechanism the drying mechanism and the winding wheel are linearly arranged in sequence; the polishing mechanism comprises a first polishing wheel and a first workbench; a first pad is arranged under the first polishing wheel; the first pad is arranged on a support;
the support is arranged on the first workbench; the support is provided with a screw and a first threaded hole matching the screw; the first workbench is provided with a second threaded hole matching the screw; the screw passes through the first threaded hole and the second threaded hole; a top of the screw abuts against a top of the support; the metal strip is drawn from the unwinding wheel to a gap between the first polishing wheel and the first pad, and then drawn to the cleaning mechanism; the cleaning mechanism comprises a second workbench and a cleaning liquid storage tank; the cleaning liquid storage tank is configured to store a cleaning liquid for cleaning the metal strip; at least one pair of felt wheels are arranged above the second workbench; the metal strip passes through the at least one pair of felt wheels; an outer circumference of the at least one pair of felt wheels is covered with a wool layer; the cleaning liquid storage tank is provided with a cleaning pipe; an upper end of the cleaning pipe is communicated with the cleaning liquid storage tank; a lower end of the cleaning pipe points to an upper surface of the metal strip; the drying mechanism comprises an oven; and after passing through the cleaning mechanism, the metal strip enters the oven, and then is wound onto the winding wheel.

2. The water-based grinding machine of claim 1, wherein a tension pulley is arranged between the unwinding wheel and the first polishing wheel; and the metal strip passes on the tension pulley.

3. The water-based grinding machine of claim 1, wherein the support comprises a support plate, a bottom plate and a guiding column, and the guiding column is arranged between the support plate and the bottom plate.

4. The water-based grinding machine of claim 1, wherein a first cover is arranged on the first workbench; a first polishing liquid storage tank is arranged on the first cover; a first polishing liquid dropper is arranged on the first polishing liquid storage tank; an upper end of the first polishing liquid dropper is communicated with the first polishing liquid storage tank; and a lower end of the first polishing liquid dropper points to the upper surface of the metal strip below the first polishing wheel.

5. The water-based grinding machine of claim 4, wherein a third workbench is arranged beside the first workbench; a second pad is arranged on the third workbench;
a second polishing wheel is arranged above the second pad; and the metal strip passes through a gap between the second polishing wheel and the second pad.

6. The water-based grinding machine of claim 5, wherein a second cover is arranged on the third workbench; a second polishing liquid storage tank is arranged on the second cover; a second polishing liquid dropper is arranged on the second polishing liquid storage tank; an upper end of the second polishing liquid dropper is communicated with the second polishing liquid storage tank; a lower end of the second polishing liquid dropper points to the upper surface of the metal strip below the second polishing wheel; and a stirrer is arranged in the second polishing liquid storage tank.

7. The water-based grinding machine of claim 6, wherein a first drain pipe is arranged on the first workbench; the first drain pipe has an upper-end opening, which is located on an upper surface of the first workbench; a sedimentation tank is provided below the third workbench; a lower end of the first drain pipe extends into the sedimentation tank; a second drain pipe is arranged on the third workbench; the second drain pipe has an upper-end opening, which is located on an upper surface of the third workbench; and a lower end of the second drain pipe extends into the sedimentation tank.

8. The water-based grinding machine of claim 1, wherein a third cover is arranged on the second workbench; and the at least one pair of felt wheels is arranged in the third cover.

9. The water-based grinding machine of claim 8, wherein a cleaning liquid recovery tank is arranged below the second workbench; the second workbench is provided with a third drain pipe; the third drain pipe has an upper-end opening, which is located on an upper surface of the second workbench; and a lower end of the third drain pipe extends into the cleaning liquid recovery tank.
